(19) United States
(12) Patent Application Publication
(10) Pub. No.: US 2012/0329001 A1
(43) Pub. Date: Dec. 27, 2012

(54) CRYSTALLIZATION APPARATUS, CRYSTALLIZATION METHOD, AND HEAT TREATMENT SYSTEM

(76) Inventors: Min-Jae JEONG, Yongin-City (KR); Ki-Yong LEE, Yongin-City (KR); Yun-Mo CHUNG, Yongin-City (KR); Dong-Hyun LEE, Yongin-City (KR); Kil-Won LEE, Yongin-City (KR)

(21) Appl. No.: 13/451,727

(22) Filed: Apr. 20, 2012

(30) Foreign Application Priority Data
Jun. 23, 2011 (KR) 10-2011-0061333

(51) Int. Cl. H05B 3/02; H05B 31/00; F27D 3/00; F27D 11/00

(52) U.S. Cl. 432/9; 432/120; 219/538; 392/416

(57) ABSTRACT

A crystallization apparatus includes a receiving unit supporting an object to be processed, a first heating unit adjacent the receiving unit, the first heating unit configured to heat the object to be processed to a first temperature during a first period, and a second heating unit adjacent the first heating unit, the second heating unit configured to heat the object to be processed to a second temperature, higher than the first temperature, during a second period that is shorter than the first period.

### CROSS-REFERENCE TO RELATED APPLICATION

This application claims priority to and the benefit of Korean Patent Application No. 10-2011-0061333 filed in the Korean Intellectual Property Office on Jun. 23, 2011, the entire contents of which are incorporated herein by reference.

### BACKGROUND

1. Field

Embodiments relate to a crystallization apparatus, a crystallization method, and a heat treatment system.

2. Description of the Related Art

A crystallization apparatus is an apparatus used to transform an amorphous object to be processed, such as amorphous silicon, into a crystallization object, such as polysilicon. A conventional crystallization apparatus uses a laser or heat to crystallize the object to be processed.

The crystallization apparatus using heat includes a hot wire that generates heat using electrical resistance. The crystallization apparatus heats the object to be processed to a predetermined temperature by using the hot wire to execute the crystallization of the object to be processed.

If the crystallization apparatus only includes the hot wire, a temperature profile for heat-treating includes a temperature increasing period, a temperature maintaining period, and a temperature decreasing period. As such, the crystallization efficiency of the object to be processed is not particularly improved.

The above information disclosed in this Background section is only for enhancement of understanding of the background of the described technology and therefore it may contain information that does not form the prior art that is already known in this country to a person of ordinary skill in the art.

### SUMMARY

One or more embodiments may provide a crystallization apparatus including: a receiving unit supporting an object to be processed, a first heating unit adjacent the receiving unit, the first heating unit configured to heat the object to be processed to a first temperature during a first period; and a second heating unit adjacent the first heating unit, the second heating unit configured to heat the object to be processed to a second temperature higher that is higher than the first temperature during a second period that is shorter than the first period.

The first heating unit may include a plurality of first heating units and the second heating unit may include a plurality of second heating units. The plurality of first heating units and the plurality of second heating units may be alternately disposed.

The first heating unit may be a heat wire configured to generate heat using electrical resistance, and the second heating unit configured to generate heat using a lamp. The lamp may include one of an infrared lamp, an ultraviolet lamp, and an arc lamp.

The receiving unit, the first heating unit, and the second heating unit may be disposed in a chamber.

The first temperature may be in a range of 100° C. to 750° C.

One or more embodiments may provide a heat treatment system including: a loading unit for loading thereon a receiving unit supporting an object to be processed; a plurality of heat treatment apparatuses connected together and aligned to extend in a direction corresponding to the direction in which the receiving unit is transferred for heat-treating; and the crystallization apparatus, as described above, positioned between neighboring heat treatment apparatuses among the plurality of heat treatment apparatuses.

One or more embodiments may provide a crystallization method including heating an object to be processed during a first period at a first temperature, and heating the object to be processed at a second temperature that is higher than the first temperature during a second period that is shorter than the first period and is included in the first period.

The first period may include a temperature increasing period in which the temperature of the object to be processed is increased to the first temperature, a temperature maintaining period in which the temperature of the object to be processed is maintained at the first temperature, and a temperature decreasing period in which the temperature of the object to be processed is decreased from the first temperature, and the second period may be within at least one period among the temperature maintaining period and the temperature decreasing period.

According to one of the above-described exemplary embodiments according to the present invention, the crystallization apparatus that improves the crystallization efficiency of the object to be processed, the crystallization method, and the heat treatment system are provided.

### BRIEF DESCRIPTION OF THE DRAWINGS

FIG. 1 illustrates a schematic of a crystallization apparatus according to the first exemplary embodiment.

FIG. 2 illustrates a schematic of a heat processor shown in FIG. 1.

FIG. 3 illustrates a flowchart of a crystallization method according to the second exemplary embodiment.

FIG. 4 illustrates a graph of the temperature profile of heat treatment in a crystallization method according to the second exemplary embodiment.

FIG. 5A illustrates a schematic view of a heat treatment system according to the third exemplary embodiment.

FIG. 5B illustrates a graph of the temperature profile of heat treatment in a crystallization method used in the heat treatment system of the third exemplary embodiment.

### DETAILED DESCRIPTION

Embodiments will be described more fully hereinafter with reference to the accompanying drawings, in which exemplary embodiments are shown. As those skilled in the art would realize, the described embodiments may be modified in various different ways, all without departing from the spirit or scope of the present invention.

Descriptions of parts not related to the embodiments are omitted, and like reference numerals designate like elements throughout the specification.

Further, with respect to embodiments other than the first embodiment, only elements other than those of the first embodiment will be described.

In the drawings, the size and thickness of each element is approximately shown for better understanding and ease of description. Therefore, the are not limited to the drawings.

In the drawings, the thickness of layers, films, panels, regions, etc., are exaggerated for clarity. Further, in the drawings, for better understanding and ease of description, the thicknesses of some layers and areas are exaggerated. It will be understood that when an element such as a layer, film, region, or substrate is referred to as being “on” another element, it can be directly on the other element or intervening elements may also be present.

In addition, unless explicitly described to the contrary, the word “comprise” and variations such as “comprises” or “comprising” will be understood to imply the inclusion of stated elements but not the exclusion of any other elements. Further, throughout the specification, “on” implies being positioned above or below a target element and does not imply being necessarily positioned on the top on the basis of a gravity direction.

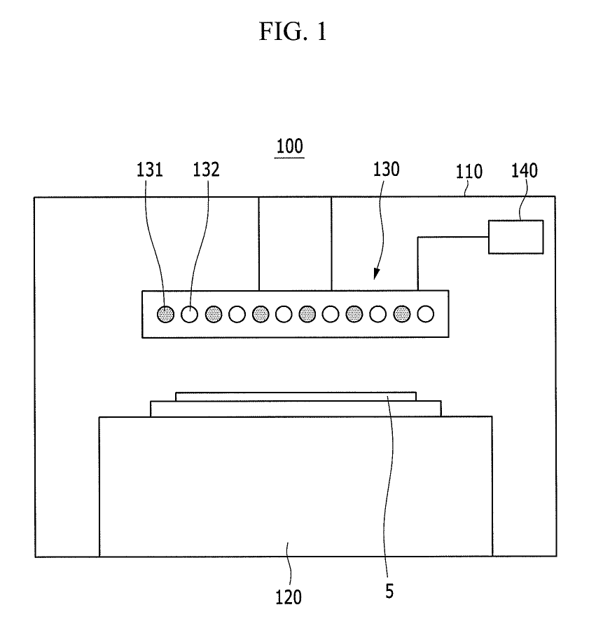

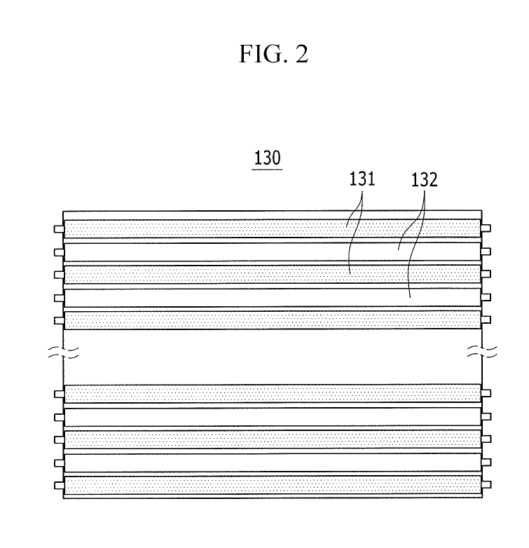

Next, referring to FIG. 1 and FIG. 2, a crystallization apparatus according to the first exemplary embodiment will be described.

FIG. 1 illustrates a schematic of a crystallization apparatus according to the first exemplary embodiment. FIG. 2 illustrates a schematic of a heat processor shown in FIG. 1.

As shown in FIG. 1, a crystallization apparatus 100 according to the first exemplary embodiment may include a chamber 110, a receiving unit 120, and a heat processor 130.

The chamber 110 may maintain a vacuum state, and an object to be processed 5 for the crystallization may be carried to or unloaded in the chamber 110. The object to be processed 5 may be a substrate, e.g., a substrate having an amorphous silicon layer.

The receiving unit 120 may be positioned inside the chamber 110 and may provide a support for receiving the object to be processed 5. The receiving unit 120 may include or be joined with a transferring mechanism, such as a roller. The receiving unit 120 may be unloaded or moved from the chamber 110, along with the object to be processed 5, and may be transferred to a neighboring heat treatment apparatus. The receiving unit 120 may position the object to be processed 5 adjacent the heat processor to heat the object to be processed 5.

The heat processor 130 may face the object to be processed 5 that is positioned on the receiving unit 120. A predetermined space may be provided between the heat processor 130 and the receiving unit 120. The heat processor 130 may be used for heating the object to be processed 5. The heat processor 130 may include a first heating unit 131 and a second heating unit 132.

The object to be processed 5 may be heated to a first temperature during a first period. The first period will be described in further detail below. The first temperature may be any suitable temperature capable of crystallizing the object to be processed 5. For example, when the object to be processed 5 includes an amorphous silicon to be crystallized into polysilicon with a metal catalyst, the first temperature may be 100° C. to 750° C., e.g., 750° C. However, the first temperature is not limited to the temperatures specifically recited herein. The first heating unit 131 may be a heating wire generating heat by using electrical resistance. The first heating unit 131 may continuously heat the object to be processed 5 at the first temperature. The first heating unit 131 may be connected to a controller 140. The controller 140 may regulate heating of the object to be processed 5 at the first temperature during the first period by the first heating unit 131. The controller 140 may be inside the chamber, as shown, or the heat processor 130 may be electrically connected to a controller 140 outside the chamber 110.

The second heating unit 132 may be positioned adjacent the first heating unit 131. The object to be processed 5 may be heated at the second temperature during the second period. The second period may be shorter than the first period. The second period may occur simultaneously with the first period. The second period will be described in further detail below. The second temperature may be any suitable temperature that is higher than the first temperature. The second heating unit 132 may heat using a lamp, e.g., an infrared lamp, an ultraviolet (UV) lamp, or an arc lamp. The second heating unit 132 may provide instant heat for heating the object to be processed 5 to the second temperature. The second heating unit 132 may be connected to a controller. The controller 140 may regulate heating of the object to be processed 5 to the second temperature during the second period by the controller.

The heat processor 130 may include a plurality of first heating units 131 and a plurality of second heating units 132 may be alternately disposed. By alternately disposing a plurality of the first heating units 131 and a plurality of second heating units 132, the object to be processed 5 may be heated to the first temperature and the second temperature in a limited space inside the chamber 110. Accordingly, without movement of the object to be processed 5, two or more heat treatments for the object to be processed 5 may be executed in one chamber 110. This configuration of the first and second heating units 131, 132, respectively may improve heat treatment efficiency for the object to be processed 5, e.g., crystallization efficiency for the object to be processed 5 may be improved.

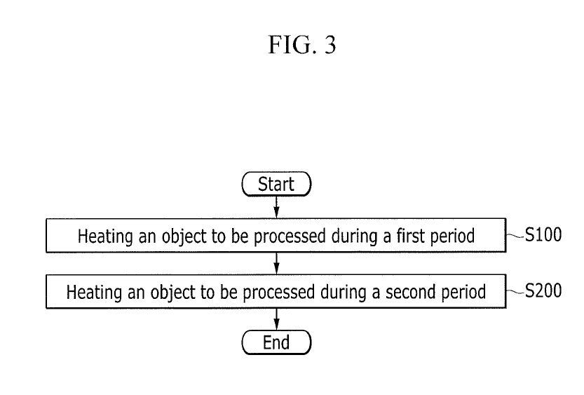

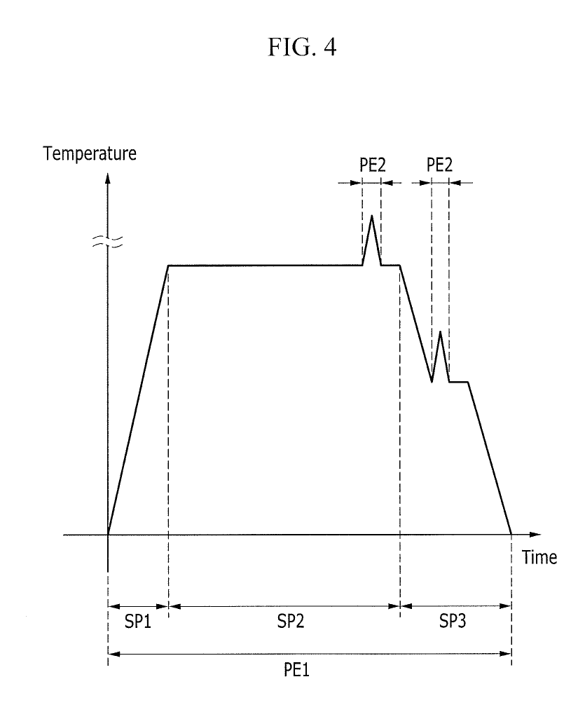

Referring to FIG. 3 and FIG. 4, a crystallization method, according to the second exemplary embodiment, using the crystallization apparatus 100 according to the first exemplary embodiment, will be described.

FIG. 3 illustrates a flowchart of a crystallization method according to the second exemplary embodiment. FIG. 4 illustrates a graph reflecting a temperature profile for heat treatment of the object to be processed in a crystallization method, according to the second exemplary embodiment. In the graph shown in FIG. 4, the x-axis represents a time for heat-treating the object to be processed, and the y-axis represents a temperature for heat-treating the object to be processed.

As shown in FIG. 3 and FIG. 4, the object to be processed 5 may first be heated to the first temperature during the first period PE1 (S100).

In detail, to crystallize the object to be processed 5, the object to be processed 5 may be heated to the first temperature during the first period PE1 using the first heating unit 131. Referring to the temperature profile for the heat treatment of the object to be processed 5, the first period PE1 may include a temperature increasing period SP1, a temperature maintaining period SP2, and a temperature decreasing period SP3. Here, the temperature increasing period SP1 may be a period in which the temperature of the object to be processed 5 is increased to the first temperature by the first heating unit 131, the temperature maintaining period SP2 may be the period in which the temperature of the object to be processed 5 is maintained at the first temperature by the first heating unit 131, and the temperature decreasing period SP3 may be a period in which the temperature of the object to be processed 5 is decreased from the first temperature by the first heating unit 131. The temperature may be any suitable temperature capable of crystallizing amorphous silicon into polysilicon by a metal catalyst. Thus, the first temperature is not limited to the temperatures recited herein. For example, the first temperature may be a range of 100° C. to 750° C. including 650° C. to 750° C.

Further, the object to be processed 5 may be heated to the second temperature during the second period PE2 (S200). In an implementation, to crystallize the object to be processed 5, the second heating unit 132 may heat the object to be processed 5 to a second temperature (that is higher than a first temperature supplied by the first heating unit 131) during the second period PE2 (that is shorter than the first period PE1 and is included in the first period PE1). Referring to the temperature profile of the heat treatment for the object to be processed 5, the second period PE2 may be within at least one period of the temperature maintaining period SP2 and the temperature decreasing period SP3 in the first period PE1. The second temperature for the temperature maintaining period SP2 and the temperature decreasing period SP3, may be different. The second temperature may be any suitable temperature higher than the temperature corresponding to each period, i.e., produced by the first heating unit 131. In the graph shown in FIG. 4, the second period PE2 may be entirely within the temperature maintaining period SP2 and the temperature decreasing period SP3 in the first period PE1.

In an implementation, based on the temperature profile of the heat treatment to crystallize the object to be processed 5, the object to be processed 5 may be instantly heated to the second temperature (that is higher than the temperature corresponding to each period), by using the second heating unit 132 in at least one period of the temperature maintaining period SP2 and the temperature decreasing period SP3.

As described above, the crystallization method, according to the second exemplary embodiment, using the crystallization apparatus 100, according to the first exemplary embodiment, may crystallize the object to be processed 5, such that the crystallization of the object to be processed 5 is accelerated, and simultaneous crystallization curing of the object to be processed 5 may be executed through one heat treatment process. As such, the crystallization efficiency of the object to be processed 5 may be improved, resulting in reduced crystallization time and crystallization cost of the object to be processed 5.

Also, when the object to be processed 5 is an active layer of a thin film transistor, the crystallization method, according to the second exemplary embodiment, using the crystallization apparatus 100, according to the first exemplary embodiment, may form the active layer from the object to be processed 5 through accelerated crystallization, thereby improving the semiconductor characteristic of the thin film transistor.

According to an embodiment, in the crystallization method, according to the second exemplary embodiment, the second period PE2 may be within the temperature maintaining period SP2 and the temperature decreasing period SP3 of the first period PE1. In a crystallization method, according to another exemplary embodiment, the second period PE2 may be only positioned at the temperature maintaining period SP2 of the first period PE1, or may be only positioned at the temperature decreasing period SP3. The occurrence of the second period PE2 may be determined according to a material included in the object to be processed 5 and the environment of heat-treating the object to be processed.

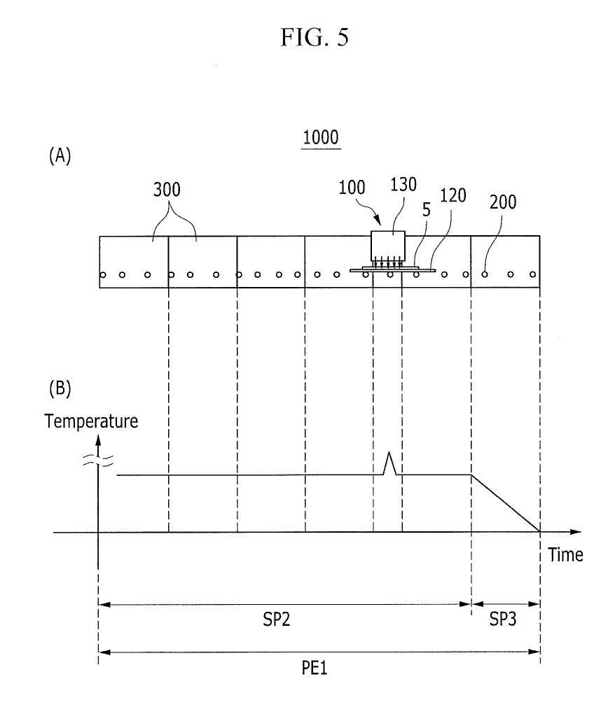

Next, referring to FIGS. 5A and 5B, a heat treatment system according to the third exemplary embodiment will be described.

FIG. 5A illustrates a schematic of a heat treatment system, according to the third exemplary embodiment. FIG. 5B illustrates a graph of a temperature profile of heat treatment to crystallize the object to be processed, in a heat treatment system according to the third exemplary embodiment. In the graph shown in FIG. 5B, the x-axis represents the time of heat treatment for the object to be processed, and the y-axis represents the temperature of heat treatment for the object to be processed.

As shown in FIG. 5A, a heat treatment system 1000, according to the third exemplary embodiment, may include a loading unit 200, a plurality of heat treatment apparatuses 300, and the above-described crystallization apparatus 100, according to the first exemplary embodiment.

The loading unit 200 may carry and transfer the receiving unit 120 that receives the object to be processed 5, in or out of a plurality of heat treatment apparatuses 300 and crystallization apparatuses 100, connected in line with each other.

The plurality of heat treatment apparatuses 300 may be used for the heat treatment of the object to be processed 5. The plurality of heat treatment apparatuses 300 may be connected to each other and aligned to extend in a direction that corresponds with the direction in which the receiving unit 120 is transferred by the loading unit 200.

The crystallization apparatus 100, according to the first exemplary embodiment, may be positioned between neighboring, i.e., adjacent, heat treatment apparatuses 300, among a plurality of heat treatment apparatuses 300.

As shown in FIG. 5B, in the heat treatment system 1000, according to the third exemplary embodiment, when the object to be processed 5 is passed through a plurality of heat treatment apparatuses 300, the object to be processed 5 may be heated at the first temperature in the temperature maintaining period SP2 within the first period PE1, and when the object to be processed 5 is passed through the crystallization apparatus 100, the object to be process 5 may be instantly heated at the second temperature that is higher than the first temperature, in the temperature maintaining period SP2, within the first period PE1.

As described above, the heat treatment system 1000, according to the third exemplary embodiment, may crystallize the object to be processed 5. The heat treatment system 1000 may, thereby, accelerate the crystallization of the object to be processed 5, and simultaneously execute the crystallization curing of the object to be processed 5 through one heat treatment process. As such, the crystallization efficiency for the object to be processed 5 may be improved, and, thereby, reduce the crystallization time and cost of the object to be processed 5.

While this disclosure has been described in connection with what is presently considered to be practical exemplary embodiments, it is to be understood that the embodiments are not limited to the disclosed embodiments, but, on the contrary, is intended to cover various modifications and equivalent arrangements included within the spirit and scope of the appended claims.

What is claimed is:

1. A crystallization apparatus, comprising:
a receiving unit supporting an object to be processed;
a first heating unit adjacent the receiving unit, the first heating unit configured to heat the object to be processed to a first temperature during a first period; and
a second heating unit adjacent to the first heating unit, the second heating unit configured to heat the object to be processed to a second temperature, higher than the first temperature, during a second period, the second period being shorter than the first period.

2. The crystallization apparatus of claim 1, wherein
the first heating unit includes a plurality of first heating units and the second heating unit includes a plurality of second heating units, and
the plurality of first heating units and the plurality of second heating units are alternately disposed.

3. The crystallization apparatus of claim 1, wherein
the first heating unit is a heat wire, the heat wire configured to generate heat using electrical resistance, and
the second heating unit is configured to generate heat using a lamp.

4. The crystallization apparatus of claim 3, wherein the lamp includes one of an infrared lamp, an ultraviolet lamp, and an arc lamp.

5. The crystallization apparatus of claim 1, wherein
the receiving unit, the first heating unit, and the second heating unit, are disposed in a chamber.

6. The crystallization apparatus of claim 1, wherein
the first temperature is in a range of 100° C. to 750° C.

7. A heat treatment system, comprising:
a loading unit for loading thereon a receiving unit supporting an object to be processed;
a plurality of heat treatment apparatuses connected together and aligned to extend in a direction corresponding to the direction in which the receiving unit is transferred for heat-treating; and
a crystallization apparatus, as claimed in claim 1, the crystallization apparatus being positioned between neighboring heat treatment apparatuses among a plurality of heat treatment apparatuses.

8. A crystallization method, comprising:
heating an object to be processed during a first period at a first temperature; and
heating the object to be processed at a second temperature that is higher than the first temperature during a second period, the second period being shorter than the first period and being included in the first period.

9. The crystallization method of claim 8, wherein
the first period includes
a temperature increasing period in which the temperature of the object to be processed is increased to the first temperature,
a temperature maintaining period in which the temperature of the object to be processed is maintained at the first temperature, and
a temperature decreasing period in which the temperature of the object to be processed is decreased from the first temperature, and
the second period is within at least one period among the temperature maintaining period and the temperature decreasing period.
